(19) United States
(12) Patent Application Publication
(10) Pub. No.: US 2025/0381902 A1
(43) Pub. Date: Dec. 18, 2025

(54) DEPLOYABLE ON DEMAND OTTOMAN FOR FOOTREST, CALF SUPPORT, AND STORAGE

(71) Applicant: GM GLOBAL TECHNOLOGY OPERATIONS LLC, Detroit, MI (US)

(72) Inventors: William Cavalcante Araujo, Claremont, CA (US); Frank Rudolph, Los Angeles, CA (US)

(73) Assignee: GM GLOBAL TECHNOLOGY OPERATIONS LLC, Detroit, MI (US)

(21) Appl. No.: 18/741,531

(22) Filed: Jun. 12, 2024

(51) Int. Cl. B60N 3/06

(52) U.S. Cl. CPC B60N 3/063

(57) ABSTRACT

Disclosed is an ottoman operatively connected to electric motor to move the ottoman. The ottoman may be connected to a floorboard of the vehicle to move by the electric motor from a first position to a second position for use by an occupant of the vehicle.

### INTRODUCTION

The technical field generally relates to ottomans, footrests, calf support, and storage in a vehicle and methods of making and using the same.

Vehicles in the future will have vastly different interior designs and may relocate the steering wheel, brake pedal, gas pedal or eliminate the same in the passenger cabin. These changes will bring demands for changes and occupant accommodation in the passenger cabin.

Accordingly, it is desirable to provide features in the passenger compartment that enhance occupant accommodations. Furthermore, other desirable features and characteristics of the patentable variations will become apparent from the subsequent detailed description and the appended claims, taken in conjunction with the accompanying drawings and the foregoing introduction.

### SUMMARY

A number of variations may include a product including: an ottoman operatively connected to an electric motor to move the ottoman from a first position configured for storage to a second position configured for use.

A number of variations may include a product further including a vehicle floorboard having at least one track formed therein, and wherein the ottoman is connected to the vehicle floorboard to travel along the at least one track.

A number of variations may include a product wherein the ottoman includes a front wall slanted at an obtuse angle with respect to vehicle floor bed and configured as a footrest.

A number of variations may include a product wherein the ottoman includes a top wall configured as a calf rest.

A number of variations may include a product wherein the ottoman includes a front wall and an opposite spaced apart backwall, a first side wall, an opposite spaced apart second side wall, and the top wall, wherein the top wall is pivotally connected one 5 wherein the front wall, the opposite spaced apart backwall, the first side wall, the opposite spaced apart second side wall a storage space in the ottoman.

A number of variations may include a product further including a control system operatively connected to the ottoman and configured to move the ottoman from the first position to the second position.

A number of variations may include a product further including a seat connected to the vehicle floorboard and wherein the first position is spaced a first distance from the seat, and wherein the second position is spaced a second distance from the seat, and wherein the first distance is greater than the second distance.

A number of variations may include a product wherein the ottoman includes a front wall slanted at an obtuse angle with respect to vehicle floor bed, and wherein the second position is a distance away from the seat so that the front wall functions as a footrest.

A number of variations may include a product wherein the ottoman includes a top wall, and wherein the second position is a distance away from the seat so that the top wall functions as a calf rest.

A number of variations may include a product wherein the ottoman further includes a front wall and an opposite spaced apart backwall, a first side wall, an opposite spaced apart second side wall, and a top wall, wherein the top wall is pivotally connected one of the front wall, the opposite spaced apart backwall, the first side wall, or the opposite spaced apart second side wall, and wherein the second position is a distance away from the seat so that an occupant sitting in the seat can pivotally move the top wall of the ottoman.

A number of variations may include a method including: providing an ottoman operatively connected to electric motor to move the ottoman along at least one track formed in a vehicle floorboard; and moving the ottoman longitudinally by the electric motor along the at least one track formed in the vehicle floorboard from a first position to a second position.

A number of variations may include a method further including providing a seat for supporting an occupant thereon and connected to the vehicle floorboard, and wherein the second position is closer to the seat than the first position.

A number of variations may include a method further including providing a seat for supporting an occupant thereon and connected to the vehicle floorboard, wherein the ottoman includes a front wall slanted at an obtuse angle with respect to the vehicle floorboard and configured to function as a footrest for the occupant sitting in the seat.

A number of variations may include a method further including providing a seat for supporting an occupant thereon and connected to the vehicle floorboard, wherein the ottoman includes a top wall configured to function as a calf rest for an occupant sitting in the seat.

A number of variations may include a method wherein the ottoman further includes a front wall and an opposite spaced apart backwall, a first side wall and an opposite spaced apart second side wall, and a top wall, wherein the top wall is pivotally connected one of the front wall, the opposite spaced apart backwall, the first side wall, or the opposite spaced apart second side wall, and wherein the second position is a distance from the seat to allow the occupant sitting in the seat to pivotally move the top wall to gain access to a storage space defined in the ottoman by the front wall, the opposite spaced apart backwall, the first side wall, the opposite spaced apart second side wall.

A number of variations may include a method further including providing a seat for supporting an occupant thereon and connected to the vehicle floorboard, further including a screen or display facing the seat and moving the ottoman from the second position to the first position, and wherein the first position is adjacent to or behind the screen or the display.

A number of variations may include a system including: a vehicle having a vehicle floorboard; configured to move an ottoman by a first electric motor along at least one track formed in the vehicle floorboard from a first position to a second position.

A number of variations may include a system further including providing an occupant seat connected to the vehicle floorboard, and wherein the second position is closer to the occupant seat than the first position, wherein the ottoman includes a front wall slanted at an obtuse angle with respect to the vehicle floorboard and configured to function as a footrest for an occupant sitting in the occupant seat, wherein the ottoman includes a top wall configured to function as a calf rest for an occupant sitting in the occupant seat.

A number of variations may include a system further including providing an occupant seat connected to the vehicle floorboard, the occupant seat having bottom cushion and a back configured for pivotal movement, wherein the ottoman includes a front wall and an opposite spaced apart backwall, a first side wall and an opposite spaced apart second side wall, and a top wall, wherein the top wall is pivotally connected one of the front wall, the opposite spaced apart backwall, the first side wall, or the opposite spaced apart second side wall, and wherein the second position is a distance from the occupant seat to allow an occupant sitting in the occupant seat to pivotally move the top wall to gain to a access storage space defined in the ottoman by the front wall, the opposite spaced apart backwall, the first side wall, the opposite spaced apart second side wall, an electric motor connected to the ottoman to move at least a portion of the ottoman from a first vertical position nearest the vehicle floorboard to a second vertical position configured to support a calf of an occupant or to position reducing the distance an occupant must move to reach into the ottoman, and wherein the back is moveable from a reclined position to an upright position reducing the distance an occupant must move to reach into the ottoman than if the back was in a recline position.

### BRIEF DESCRIPTION OF THE DRAWINGS

The illustrative variations will hereinafter be described in conjunction with the following drawing figures, wherein like numerals denote like elements, and wherein:

FIG. 1 is a side view of a vehicle with portions removed illustrating a deployable ottoman positioned as a footrest according to a number of variations;

FIG. 2 is a perspective view of a vehicle with portions removed illustrating a deployable ottoman positioned as a footrest according to a number of variations;

FIG. 3 is a perspective view of a deployable ottoman according to a number of variations;

FIG. 4 is a side view with portions removed of a vehicle including a deployable ottoman positioned to be a calf rest according to a number of variations;

FIG. 5 is a perspective view with portions removed of a vehicle including a deployable ottoman positioned to be a calf rest according to a number of variations;

FIG. 6 is a side view with portions removed of a vehicle including a deployable ottoman positioned to access a storage area provided in the deployable ottoman according to a number of variations;

FIG. 7 is a perspective view with portions removed of a vehicle including a deployable ottoman positioned to access a storage area provided in the deployable ottoman according to a number of variations;

FIG. 8 is a perspective view of a deployable ottoman with a top wall in an open position according to a number of variations;

FIG. 9 is a schematic illustration of a system for operating a deployable ottoman according to a number of variations;

FIG. 10 is a schematic illustration of a portion of a vehicle including portions of a pair of tracks formed in a floorboard of the vehicle for use in moving a deployable ottoman according to a number of variations;

FIG. 11 is a schematic side view of a portion of a deployable ottoman operatively connected to a motor for selectively moving a deployable ottoman according to a number of variations;

FIG. 12 is a schematic side view of a portion of a deployable ottoman operatively connected to a motor for selectively moving a deployable ottoman according to a number of variations;

FIG. 13 is a perspective and schematic illustration of a system for linear movement of a deployable ottoman according to a number of variations;

FIG. 14 is a perspective and schematic illustration of a system for linear movement of a deployable ottoman according to a number of variations;

FIG. 15 is a side view of a vehicle with portions removed illustrating a deployable ottoman with height adjustment functionality positioned as a storage position according to a number of variations;

FIG. 16 is a side view with portions removed of a vehicle including a deployable ottoman with height adjustment functionality positioned to access a storage area provided in the deployable ottoman and wherein the occupant seat back has been moved to an upright position according to a number of variations;

FIG. 17 is a side view with portions removed of a vehicle including a deployable ottoman with height adjustment functionality positioned to access a storage area provided in the deployable ottoman wherein at least a portion of the ottoman has been lifted to an elevated position and wherein the occupant seat back has been moved to an upright position according to a number of variations;

FIG. 18 is a perspective, side view of a vehicle with portions removed illustrating a deployable ottoman with height adjustment functionality positioned as a storage position according to a number of variations;

FIG. 19 is a perspective, side view with portions removed of a vehicle including a deployable ottoman with height adjustment functionality positioned to access a storage area provided in the deployable ottoman and wherein the occupant seat back has been moved to an upright position according to a number of variations; and

FIG. 20 is a side view with portions removed of a vehicle including a deployable ottoman with height adjustment functionality positioned to access a storage area provided in the deployable ottoman wherein at least a portion of the ottoman has been lifted to an elevated position and wherein the occupant seat back has been moved to an upright position according to a number of variations.

### DETAILED DESCRIPTION

The following detailed description is merely exemplary in nature and is not intended to limit the application and uses. Furthermore, there is no intention to be bound by any expressed or implied theory presented in the preceding introduction, brief description of the drawings, brief summary or the following detailed description.

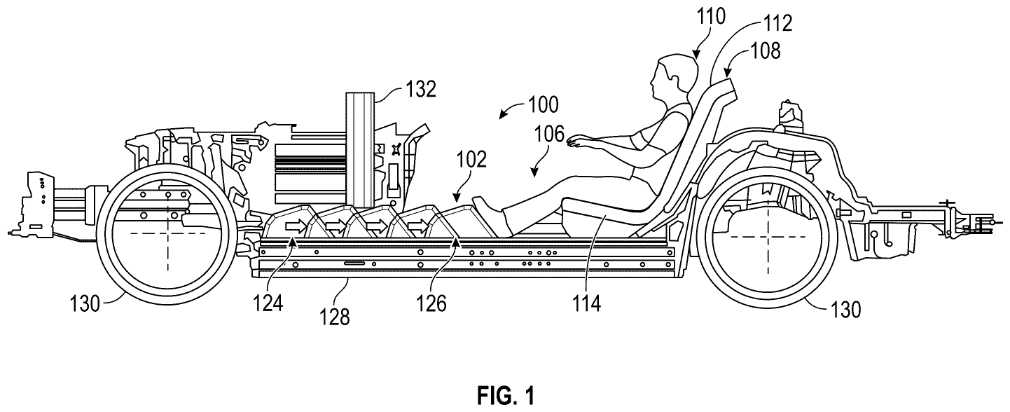

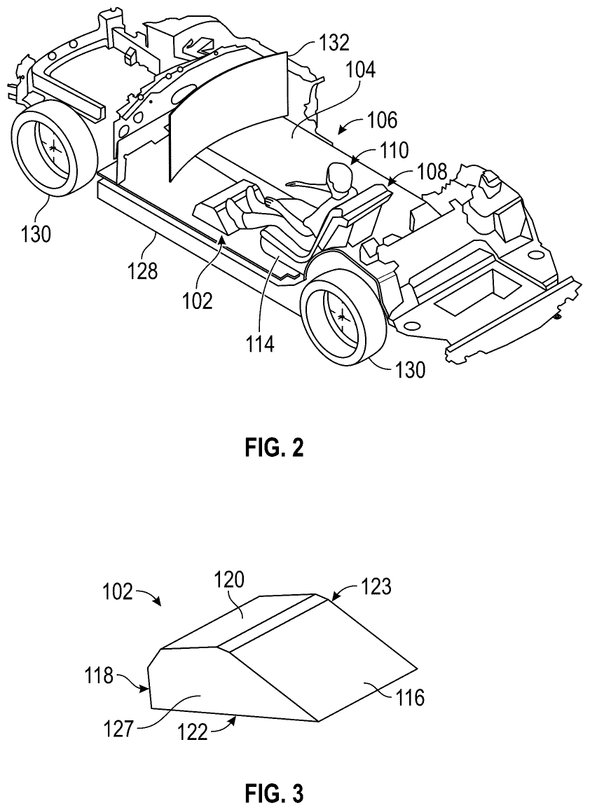

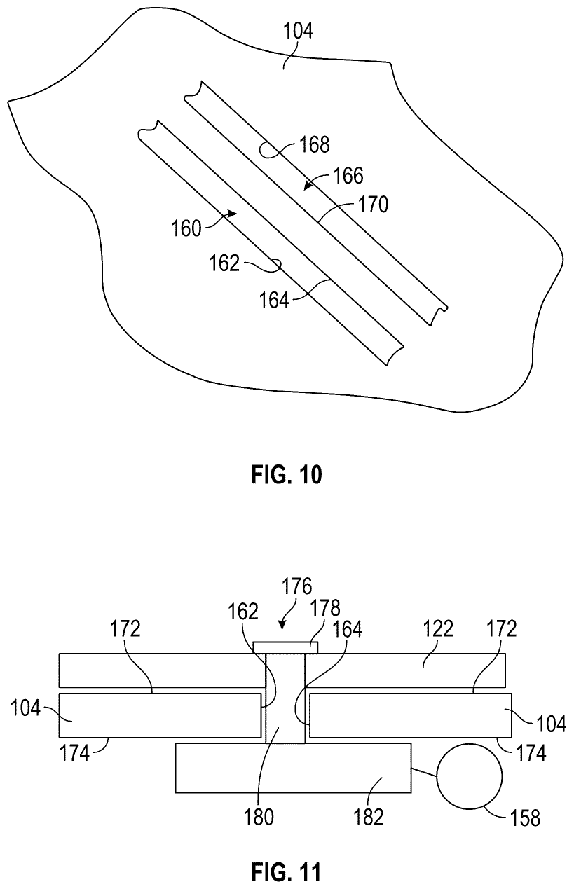

FIGS. 1-3 and 9-10 illustrate a number of variations, which may include a deployable ottoman 102 operatively connected to an electric motor 158 to move the deployable ottoman 102. In a number of variations, the deployable ottoman 102 may be positioned in a vehicle 100 so that the deployable ottoman 102 may be moved by the electric motor 158 along a first track 160 and/or a second track 166 formed in a vehicle floorboard 104 (best seen in FIG. 10) in a passenger cabin 106 of the vehicle 100. A seat 108 may be provided in the passenger cabin 106 to support an occupant 110. The seat may include a back 112 and a bottom cushion 114. The deployable ottoman 102 may be movable from a first position 124 a first distance away from the seat 108 to a second position 126 which is a second distance away from the seat 108. The second position 126 may be closer to the seat 108 than the first position 124. The first position 124 may be such that the deployable ottoman 102 is adjacent to a display or screen 132 or may be behind the display or screen 132. In a number of variations, the passenger cabin 106 may not include a steering wheel, brake pedal, or propulsion pedal. In a number of variations, the vehicle 100 may be capable of autonomous driving wherein a passenger such as the driver of the vehicle does not need to control the vehicle using a steering wheel, brake pedal, or propulsion pedal. In a number of variations, the vehicle may operate in an autonomous or semi-autonomous manner using control logic executed by a control system using an electronic process, non-transitory digital storage medium with written instructions stored thereon executable by the electronic processor. Control of the vehicle may at times be achieved by a human driver using any of a variety of devices such as, but not limited to, a joystick, voice controls, displays, or buttons without using a traditional steering wheel, brake pedal or propulsion pedal. The deployable ottoman 102 may include a front wall 116 and an opposite back wall 118, a first sidewall 123 and an opposite second side wall 127, and a top wall 120 extending between the front wall 116, the opposite back wall 118, the first sidewall 123 and the opposite second side wall 127. As illustrated in FIG. 2, the deployable ottoman 102 may be moved from a first position 124 to a second position 126 so an occupant 110 may use the front wall 116 of the deployable ottoman 102 as a footrest.

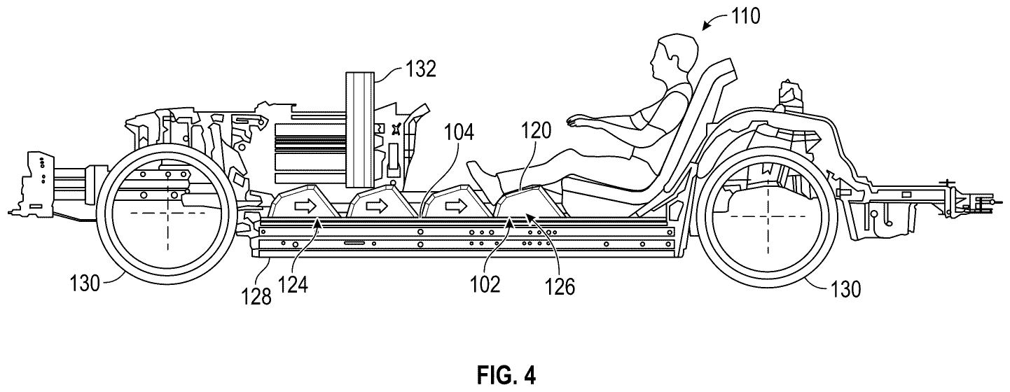

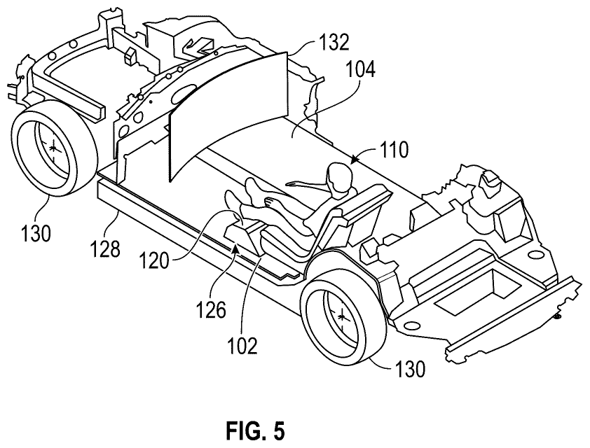

A number of variations are illustrated in FIGS. 4-5 wherein the deployable ottoman 102 may be moved from a first position 124 to a second position 126 so that an occupant 110 may use the top wall 120 of the deployable ottoman 102 as a calf rest.

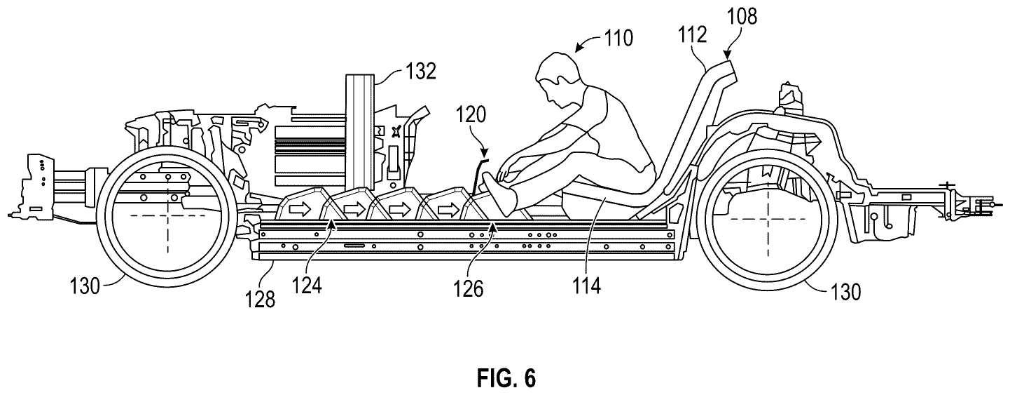

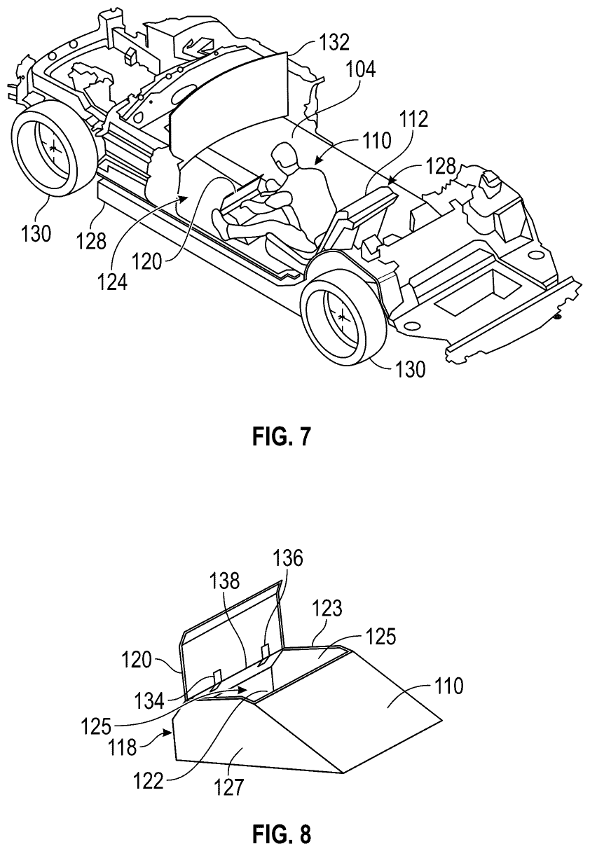

A number of variations are illustrated in FIGS. 6-8 wherein the deployable ottoman 102 may be moved from the first position 124 to the second position 126 so that an occupant 110 may lift the top wall 120 of the deployable ottoman 102 to gain access to a storage space 125 defined in the deployable ottoman 102. The top wall 120 may be pivotally connected to one of the back wall 118, first sidewall 123 or the opposite second side wall 127. In a number of variations, the top wall 120 may be pivotally connected by a first hinge 134 and/or a second hinge 136 each joining with the top wall 120 and the back wall 118. In an alternative variation, a flexible hinge 138 may be provided between the top wall 120 and one of the back wall 118, first sidewall 123 or the opposite second side wall 127. The flexible hinge 138 may be made from the same material as the top wall 120 but of a thinner thickness sufficient to function as a hinge. In a number of variations, the flexible hinge 138 may be made from a material different than the top wall 120.

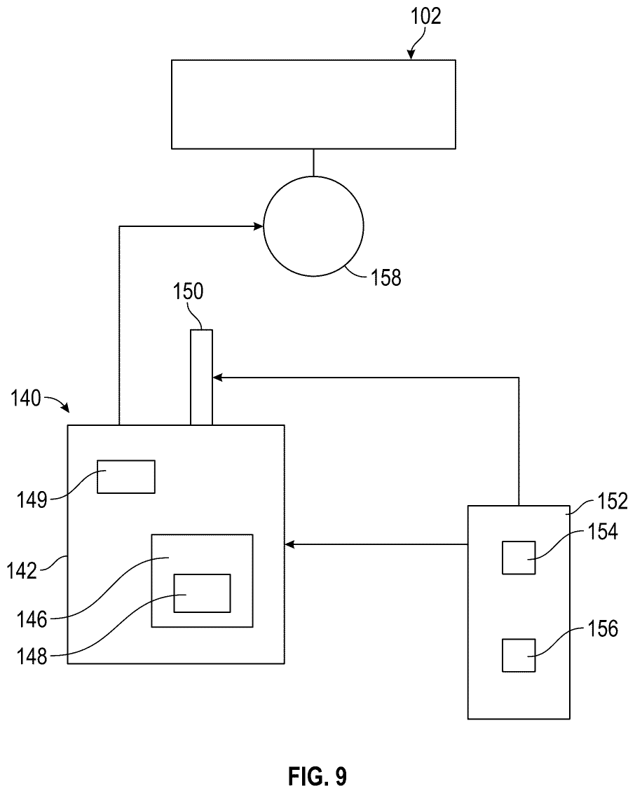

FIG. 9 illustrates a number of variations, which may include a control system 140 which may include a computing device 142 including electronic processor 144 and a non-transitory digital storage media 146 having written instructions 148 stored thereon executable by the electronic processor 144 to carry out or achieve any act, step, method, or functionality described herein. The control system 140 or a similar control system may be used to operate the vehicle in an autonomous or semi-autonomous manner. A controller 152 which may be provided in a structure in the passenger cabin 106 of the vehicle 100 such, as but not limited to, the display or screen 132 (shown for example in FIGS. 1-2, 4-5, 6-7) or may be handheld. The controller 152 may include a first input component 154 which may be a button on a handheld device or a widget on a screen, display, or computer, and may include a second input component 156. In a number of variations, the first input component 154 may be used to send a signal to the control system 140 which may be operatively connected to an electric motor 158 which may be operatively connected to the deployable ottoman 102 to move the deployable ottoman 102 in a first direction which, for example, may be toward the first position 124 (shown in FIGS. 1, 4, 6) and the second input component 156 may be utilized to send a signal to the control system 140 to move the deployable ottoman 102 in a second direction, which may be toward the second position 126 (shown in FIGS. 1, 4, 6). The control system 140 may include a communication means 150 such as, but not limited to, an antenna to receive requests to move the deployable ottoman 102 by Wi-Fi, Bluetooth, or radio signals. The control system 140 may also be configured to receive and respond to voice requests to move the deployable ottoman 102.

FIGS. 10-11 illustrates a number of variations which may include a vehicle floorboard 104 having a first track 160, which may be a slot defined by a first vertical wall 162 and a spaced apart second vertical wall 164 formed in the vehicle floorboard 104 extending from a top face 172 to a bottom face 174 of the vehicle floorboard 104. Similarly, a second track 166 may be a second slot formed in the vehicle floorboard 104 defined by a third vertical wall 168 and a spaced apart fourth vertical wall 170 extending from the top face 172 to the bottom face 174 of the vehicle floorboard 104. As illustrated in FIG. 11, a connector 176 extending through the bottom wall 122 of the deployable ottoman 102 and into or through a table 182 operatively connected to the electric motor 158 constructed and arranged to move in a first direction and a second direction to provide linear motion of the deployable ottoman 102 from the first position 124 to the second position 126 and vice versa or anywhere therebetween.

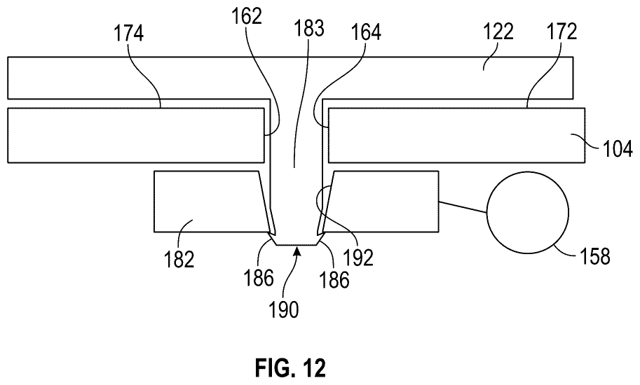

FIG. 12 illustrates a number of variations, which may include the bottom wall 122 of the deployable ottoman 102 having an elongated projection 183 extending therefrom which may include at least one flexible finger 186 at a free end 190 thereof so that the elongated projection 183 may be press fit through a table wall 192 formed in the table 182. The deployable ottoman 102 may be moved by a variety of linear movement transport systems including for example, but not limited to, a ball screw linear movement system, a rack and pinion linear movement system, or a timing belt linear movement system.

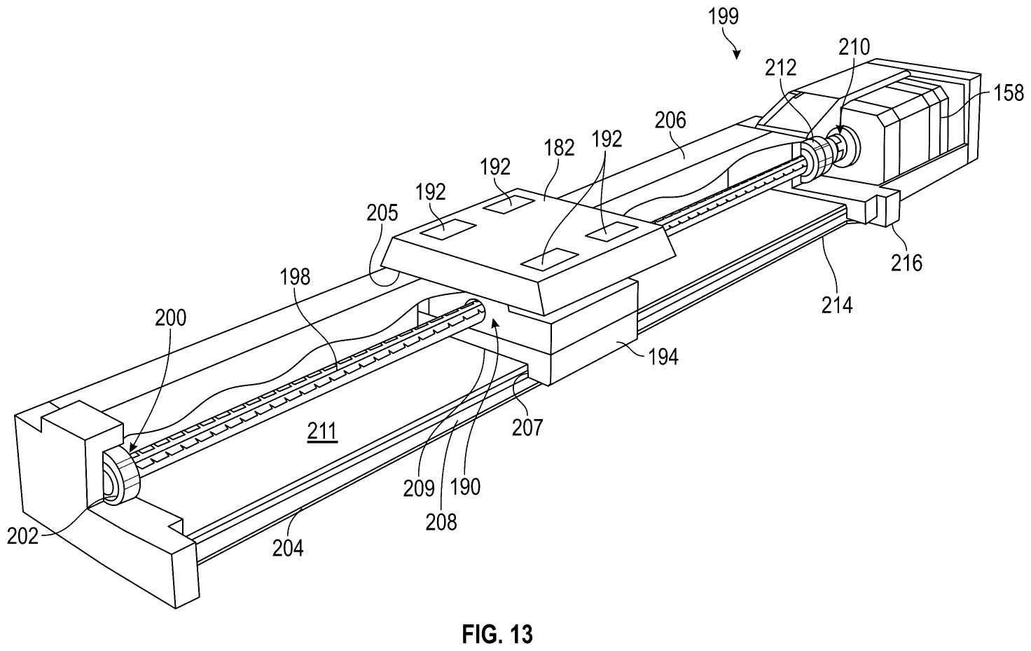

FIG. 13 illustrates a number of variations which may include a ball screw linear movement system 199 which may include a ball screw 198 having a first end 210 operatively connected to electric motor 158 and having a second end 200 received in a bearing 202 supported by a guide rail 204. The ball screw 198 may extend through a guide block 194 having a ball screw nut 196 therein for engagement with threats of the ball screw 198. The table 182 may be attached to the guide block 194 and may have a table wall 192 defining recess therein or through hole. The guide block 194 may be L-shaped and may a bottom surface 205 of the table 182 may slide along a top surface 206 of the guide rail 204 and first surface 207 may slide along an edge 208 of the guide rail 204 and a second surface 209 may slide along a base surface 211 of the guide rail 204.

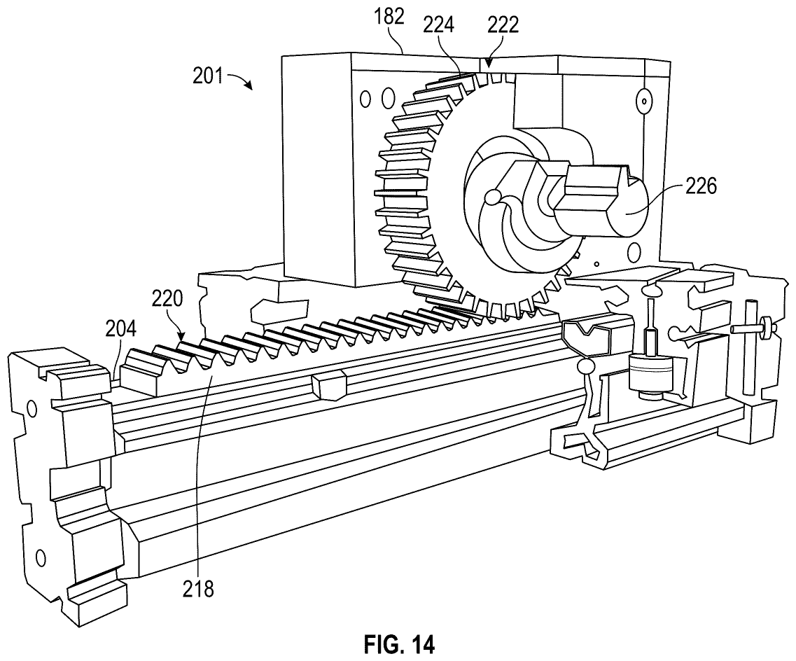

FIG. 14 illustrates a number of variations which may include a rack and pinion linear movement system 201 which may include a guide rail 204 and a rack 218 attached thereto having a first set of a plurality of spaced apart teeth 220. A pinion gear 222 may include a second set of a plurality of spaced apart teeth 224 for mating with the first set of a plurality of spaced apart teeth 220. A pinion gear shaft 226 may be connected to the pinion gear 222 and a motor (not shown) may be connected to the pinion gear shaft 226 to rotate the pinion gear 222 to linearly move the table 182 operatively connected to the pinion gear 222.

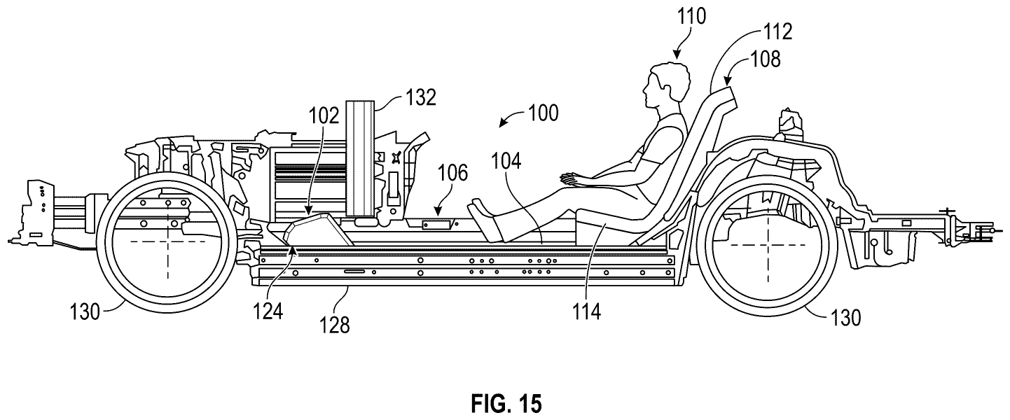

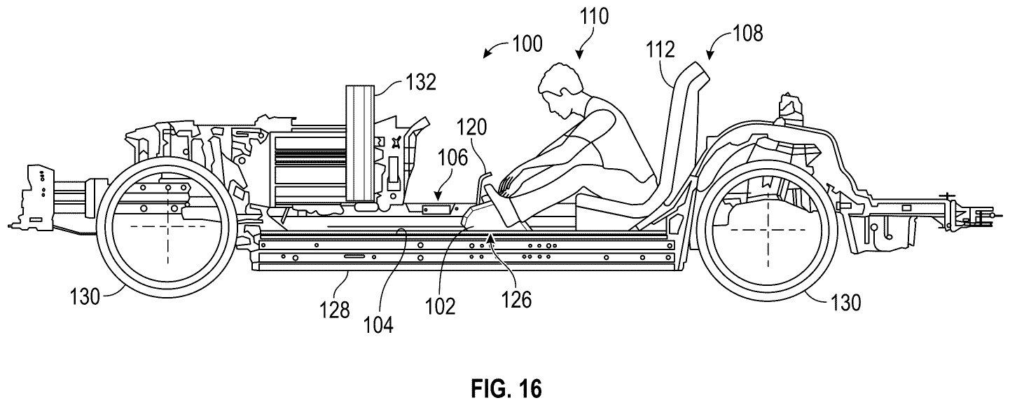

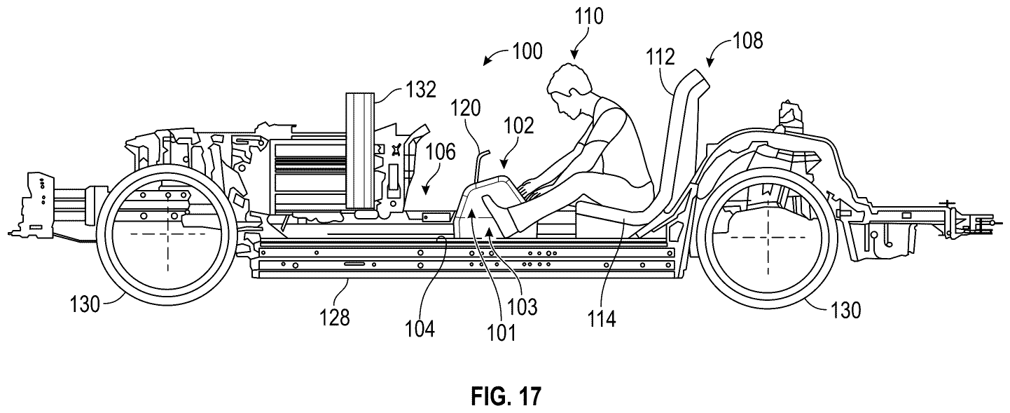

A number of variations are illustrated by FIG. 15, which is a side view of a vehicle with portions removed illustrating a deployable ottoman 102 with height adjustment functionality positioned as a first position 124, which may be a storage position according to a number of variations. As illustrated in FIGS. 15-16, the deployable ottoman 102 with height adjustment functionality may be moved from the first position 124 to a second position 126 wherein an occupant 110 may reach to open the top wall 120 of the deployable ottoman 102. To assist the occupant 110, the back 112 of the seat 108 may be moved from a reclined position, for example as shown in FIG. 15, to an upright position, for example as shown in FIG. 16. The change in the position to back 112 to an upright position makes it easier for the occupant 110 to reach the deployable ottoman 102. A number of variations are illustrated in FIG. 17 wherein the deployable ottoman 102 may include a first portion 101 and a second portion 103. At least a first portion 101 of the ottoman has been lifted to an elevated position above the vehicle floorboard 104. In a number of variations, a linear actuator, for example as shown in FIGS. 13-14 may be operatively connected to the deployable ottoman 102 to lift at least a first portion 101 or all of the deployable ottoman 102. The back 112 may be moved, manually or by electric motor, to an upright position which may reduce the distance an occupant 110 must move to reach into the deployable ottoman 102 than if the back 112 was in the recline position. In a number of variations at least a portion of the deployable ottoman 102 may be lifted to an elevated position by an electric motor to adjust the comfort of the occupant having a calf supported by the deployable ottoman.

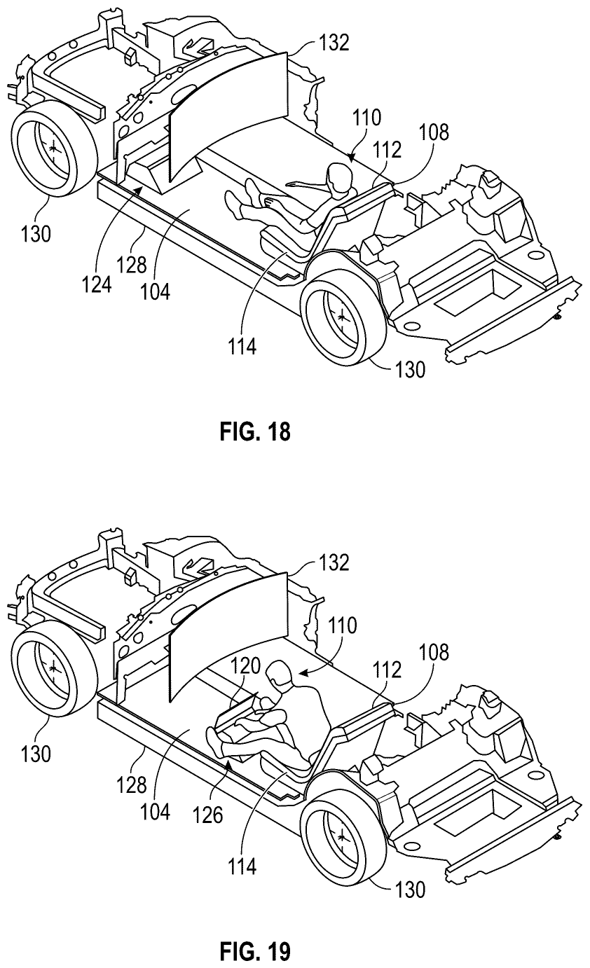

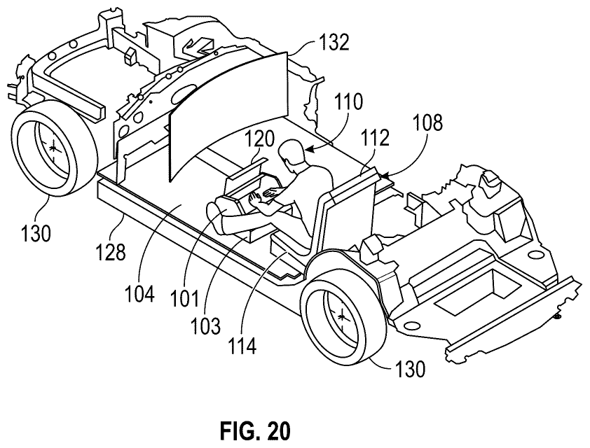

A number of variations are illustrated by FIG. 18, which is a perspective, side view of a vehicle with portions removed illustrating a deployable ottoman 102 with height adjustment functionality positioned as a first position 124, which may be a storage position according to a number of variations. As illustrated in FIGS. 18-19, the deployable ottoman 102 with height adjustment functionality may be moved from the first position 124 to a second position 126 wherein an occupant 110 may reach to open the top wall 120 of the deployable ottoman 102. To assist the occupant 110, the back 112 of the seat 108 may be moved from a reclined position, for example as shown in FIG. 15, to an upright position, for example as shown in FIG. 19. The change in the position to back 112 to an upright position makes it easier for the occupant 110 to reach the deployable ottoman 102. A number of variations are illustrated in FIG. 20 wherein the deployable ottoman 102 may include a first portion 101 and a second portion 103. At least a first portion 101 of the ottoman has been lifted to an elevated position above the vehicle floorboard 104. In a number of variations, a linear actuator, for example as shown in FIGS. 13-14 may be operatively connected to the deployable ottoman 102 to lift at least a first portion 101 or all of the deployable ottoman 102. The back 112 may be moved, manually or by electric motor, to an upright position which may reduce the distance an occupant 110 must move to reach into the deployable ottoman 102 than if the back 112 was in the recline position. In a number of variations at least a portion of the deployable ottoman 102 may be lifted to an elevated position by an electric motor to adjust the comfort of the occupant having a calf supported by the deployable ottoman.

Clause 1. A product, comprising: an ottoman operatively connected to an electric motor to move the ottoman from a first position configured for storage to a second position configured for use.

Clause 2. The product as set forth in clause 1 further comprising a vehicle floorboard having at least one track formed therein, and wherein the ottoman is connected to the vehicle floorboard to travel along the at least one track.

Clause 3. The product as set forth as set forth in clause 2 wherein the ottoman comprises a front wall slanted at an obtuse angle with respect to vehicle floor bed and configured as a footrest.

Clause 4. The product is set forth in clause 2 wherein the ottoman includes a top wall configured as a calf rest.

Clause 5. The product as set forth in clause 4 wherein the ottoman comprises a front wall and an opposite spaced apart backwall, a first side wall, an opposite spaced apart second side wall, and the top wall, wherein the top wall is pivotally connected one of the front wall, the opposite spaced apart backwall, the first side wall, or the opposite spaced apart second side wall. 6 The product as set forth in claim 5 wherein the front wall, the opposite spaced apart backwall, the first side wall, the opposite spaced apart second side wall a storage space in the ottoman.

Clause 7. The product as set forth in clause 2 further comprising a control system operatively connected to the ottoman and configured to move the ottoman from the first position to the second position.

Clause 8. The product as set forth in clause 7 further comprising a seat connected to the vehicle floorboard and wherein the first position is spaced a first distance from the seat, and wherein the second position is spaced a second distance from the seat, and wherein the first distance is greater than the second distance.

Clause 9. The product as set forth in clause 8 wherein the ottoman comprises a front wall slanted at an obtuse angle with respect to vehicle floor bed, and wherein the second position is a distance away from the seat so that the front wall functions as a footrest.

Clause 10. The product is set forth in clause 8 wherein the ottoman includes a top wall, and wherein the second position is a distance away from the seat so that the top wall functions as a calf rest.

Clause 11. The product as set forth in clause 8 wherein the ottoman further comprises a front wall and an opposite spaced apart backwall, a first side wall, an opposite spaced apart second side wall, and a top wall, wherein the top wall is pivotally connected one of the front wall, the opposite spaced apart backwall, the first side wall, or the opposite spaced apart second side wall, and wherein the second position is a distance away from the seat so that an occupant sitting in the seat can pivotally move the top wall of the ottoman.

Clause 12. A method, comprising providing an ottoman operatively connected to electric motor to move the ottoman along at least one track formed in a vehicle floorboard; and moving the ottoman longitudinally by the electric motor along the at least one track formed in the vehicle floorboard from a first position to a second position.

Clause 13. The method as set forth in clause 12 further comprising providing a seat for supporting an occupant thereon and connected to the vehicle floorboard, and wherein the second position is closer to the seat than the first position.

Clause 14. The method as set forth in clause 12 further comprising providing a seat for supporting an occupant thereon and connected to the vehicle floorboard, wherein the ottoman comprises a front wall slanted at an obtuse angle with respect to the vehicle floorboard and configured to function as a footrest for the occupant sitting in the seat.

Clause 15. The method as set forth in clause 12 further comprising providing a seat for supporting an occupant thereon and connected to the vehicle floorboard, wherein the ottoman comprises a top wall configured to function as a calf rest for an occupant sitting in the seat.

Clause 16. The method as set forth in clause 13 wherein the ottoman further comprises a front wall and an opposite spaced apart backwall, a first side wall and an opposite spaced apart second side wall, and a top wall, wherein the top wall is pivotally connected one of the front wall, the opposite spaced apart backwall, the first side wall, or the opposite spaced apart second side wall, and wherein the second position is a distance from the seat to allow the occupant sitting in the seat to pivotally move the top wall to gain access to a storage space defined in the ottoman by the front wall, the opposite spaced apart backwall, the first side wall, the opposite spaced apart second side wall.

Clause 17. The method as set forth in clause 12 further comprising providing a seat for supporting an occupant thereon and connected to the vehicle floorboard, further comprising a screen or display facing the seat and moving the ottoman from the second position to the first position, and wherein the first position is adjacent to or behind the screen or the display.

Clause 18. A system comprising: a vehicle having a vehicle floorboard; configured to move an ottoman by a first electric motor along at least one track formed in the vehicle floorboard from a first position to a second position.

Clause 19. The system as set forth in clause 18 further comprising providing an occupant seat connected to the vehicle floorboard, and wherein the second position is closer to the occupant seat than the first position, wherein the ottoman comprises a front wall slanted at an obtuse angle with respect to the vehicle floorboard and configured to function as a footrest for an occupant sitting in the occupant seat, wherein the ottoman comprises a top wall configured to function as a calf rest for an occupant sitting in the occupant seat.

Clause 20. The system as set forth in clause 18 further comprising providing an occupant seat connected to the vehicle floorboard, the occupant seat having bottom cushion and a back configured for pivotal movement, wherein the ottoman comprises a front wall and an opposite spaced apart backwall, a first side wall and an opposite spaced apart second side wall, and a top wall, wherein the top wall is pivotally connected one of the front wall, the opposite spaced apart backwall, the first side wall, or the opposite spaced apart second side wall, and wherein the second position is a distance from the occupant seat to allow an occupant sitting in the occupant seat to pivotally move the top wall to gain to a access storage space defined in the ottoman by the front wall, the opposite spaced apart backwall, the first side wall, the opposite spaced apart second side wall, an electric motor connected to the ottoman to move at least a portion of the ottoman from a first vertical position nearest the vehicle floorboard to a second vertical position configured to support a calf of an occupant or to position reducing the distance an occupant must move to reach into the ottoman, and wherein the back is moveable from a reclined position to an upright position reducing the distance an occupant must move to reach into the ottoman than if the back was in a recline position.

While at least one variation has been presented in the foregoing detailed description, it should be appreciated that a vast number of variations exist. It should also be appreciated that the variation or variations are only examples, and are not intended to limit the scope, applicability, or configuration of the disclosure in any way. Rather, the foregoing detailed description will provide those skilled in the art with a convenient road map for implementing the illustrative variation or variations. It should be understood that various changes can be made in the function and arrangement of elements without departing from the scope of the disclosure as set forth in the appended claims and the legal equivalents thereof.

What is claimed is:

1. A product, comprising:
an ottoman operatively connected to an electric motor to move the ottoman from a first position configured for storage to a second position configured for use.

2. The product as set forth in claim 1 further comprising a vehicle floorboard having at least one track formed therein, and wherein the ottoman is connected to the vehicle floorboard to travel along the at least one track.

3. The product as set forth as set forth in claim 2 wherein the ottoman comprises a front wall slanted at an obtuse angle with respect to vehicle floor bed and configured as a footrest.

4. The product is set forth in claim 2 wherein the ottoman includes a top wall configured as a calf rest.

5. The product as set forth in claim 4 wherein the ottoman comprises a front wall and an opposite spaced apart backwall, a first side wall, an opposite spaced apart second side wall, and the top wall, wherein the top wall is pivotally connected one of the front wall, the opposite spaced apart backwall, the first side wall, or the opposite spaced apart second side wall.

6. The product as set forth in claim 5 wherein the front wall, the opposite spaced apart backwall, the first side wall, the opposite spaced apart second side wall a storage space in the ottoman.

7. The product as set forth in claim 2 further comprising a control system operatively connected to the ottoman and configured to move the ottoman from the first position to the second position.

8. The product as set forth in claim 7 further comprising a seat connected to the vehicle floorboard and wherein the first position is spaced a first distance from the seat, and wherein the second position is spaced a second distance from the seat, and wherein the first distance is greater than the second distance.

9. The product as set forth in claim 8 wherein the ottoman comprises a front wall slanted at an obtuse angle with respect to vehicle floor bed, and wherein the second position is a distance away from the seat so that the front wall functions as a footrest.

10. The product is set forth in claim 8 wherein the ottoman includes a top wall, and wherein the second position is a distance away from the seat so that the top wall functions as a calf rest.

11. The product as set forth in claim 8 wherein the ottoman further comprises a front wall and an opposite spaced apart backwall, a first side wall, an opposite spaced apart second side wall, and a top wall, wherein the top wall is pivotally connected one of the front wall, the opposite spaced apart backwall, the first side wall, or the opposite spaced apart second side wall, and wherein the second position is a distance away from the seat so that an occupant sitting in the seat can pivotally move the top wall of the ottoman.

12. A method, comprising:
providing an ottoman operatively connected to electric motor to move the ottoman along at least one track formed in a vehicle floorboard; and
moving the ottoman longitudinally by the electric motor along the at least one track formed in the vehicle floorboard from a first position to a second position.

13. The method as set forth in claim 12 further comprising providing a seat for supporting an occupant thereon and connected to the vehicle floorboard, and wherein the second position is closer to the seat than the first position.

14. The method as set forth in claim 12 further comprising providing a seat for supporting an occupant thereon and connected to the vehicle floorboard, wherein the ottoman comprises a front wall slanted at an obtuse angle with respect to the vehicle floorboard and configured to function as a footrest for the occupant sitting in the seat.

15. The method as set forth in claim 12 further comprising providing a seat for supporting an occupant thereon and connected to the vehicle floorboard, wherein the ottoman comprises a top wall configured to function as a calf rest for an occupant sitting in the seat.

16. The method as set forth in claim 13 wherein the ottoman further comprises a front wall and an opposite spaced apart backwall, a first side wall and an opposite spaced apart second side wall, and a top wall, wherein the top wall is pivotally connected one of the front wall, the opposite spaced apart backwall, the first side wall, or the opposite spaced apart second side wall, and wherein the second position is a distance from the seat to allow the occupant sitting in the seat to pivotally move the top wall to gain access to a storage space defined in the ottoman by the front wall, the opposite spaced apart backwall, the first side wall, the opposite spaced apart second side wall.

17. The method as set forth in claim 12 further comprising providing a seat for supporting an occupant thereon and connected to the vehicle floorboard, further comprising a screen or display facing the seat and moving the ottoman from the second position to the first position, and wherein the first position is adjacent to or behind the screen or the display.

18. A system comprising:
a vehicle having a vehicle floorboard;
configured to move an ottoman by a first electric motor along at least one track formed in the vehicle floorboard from a first position to a second position.

19. The system as set forth in claim 18 further comprising providing an occupant seat connected to the vehicle floorboard, and wherein the second position is closer to the occupant seat than the first position, wherein the ottoman comprises a front wall slanted at an obtuse angle with respect to the vehicle floorboard and configured to function as a footrest for an occupant sitting in the occupant seat, wherein the ottoman comprises a top wall configured to function as a calf rest for an occupant sitting in the occupant seat.

20. The system as set forth in claim 18 further comprising providing an occupant seat connected to the vehicle floorboard, the occupant seat having bottom cushion and a back configured for pivotal movement, wherein the ottoman comprises a front wall and an opposite spaced apart backwall, a first side wall and an opposite spaced apart second side wall, and a top wall, wherein the top wall is pivotally connected one of the front wall, the opposite spaced apart backwall, the first side wall, or the opposite spaced apart second side wall, and wherein the second position is a distance from the occupant seat to allow an occupant sitting in the occupant seat to pivotally move the top wall to gain to a access storage space defined in the ottoman by the front wall, the opposite spaced apart backwall, the first side wall, the opposite spaced apart second side wall, an electric motor connected to the ottoman to move at least a portion of the ottoman from a first vertical position nearest the vehicle floorboard to a second vertical position configured to support a calf of an occupant or to position reducing the distance an occupant must move to reach into the ottoman, and wherein the back is moveable from a reclined position to an upright position reducing the distance an occupant must move to reach into the ottoman than if the back was in a recline position.
